(19) United States
(12) Patent Application Publication
(10) Pub. No.: US 2022/0357421 A1
(43) Pub. Date: Nov. 10, 2022

(54) OPTICAL FIBER SENSING SYSTEM AND SOUND SOURCE POSITION IDENTIFICATION METHOD

(71) Applicant: NEC Corporation, Minato-ku, Tokyo (JP)

(72) Inventor: Takashi KOJIMA, Tokyo (JP)

(73) Assignee: NEC Corporation, Minato-ku, Tokyo (JP)

(21) Appl. No.: 17/619,885

(22) PCT Filed: Jun. 20, 2019
(86) PCT No.: PCT/JP2019/024599

§ 371 Date: Dec. 16, 2021

(51) Int. Cl. G01S 5/20; G01H 9/00

(52) U.S. Cl. CPC G01S 5/20; G01H 9/004

(57) ABSTRACT

An optical fiber sensing system according to the present disclosure includes: an optical fiber (10) disposed to lie in a plurality of directions and configured to sense sound generated in a monitored area; a reception unit (20) configured to receive, from the optical fiber (10), an optical signal on which the sound is superimposed; and an identification unit (30) configured to analyze distribution of the sound sensed by the optical fiber (10) based on the optical signal and identify a generation position of the sound based on the analyzed distribution of the sound.

### TECHNICAL FIELD

The present disclosure relates to an optical fiber sensing system and a sound source position identification method.

### BACKGROUND ART

In a recent technology what is called optical fiber sensing, an optical fiber is used as a sensor. The optical fiber enables superimposition of sound on an optical signal transmitted through the optical fiber, and thus the sound can be sensed by using the optical fiber.

Another technology is proposed to identify the generation position of sound by using an optical fiber.

For example, Patent Literature 1 discloses a device configured to sense anomalous sound such as gas leakage sound by using optical fibers routed inside a gas pipe. In the device disclosed in Patent Literature 1, a plurality of light acoustic medium units are connected to each other through the optical fibers inside the gas pipe, and the position of a light acoustic medium unit having sensed anomalous sound is determined as the generation position of the anomalous sound.

### CITATION LIST

### Patent Literature

Patent Literature 1: Japanese Patent Laid-open No. 2013-253831

### SUMMARY OF INVENTION

### Technical Problem

As described above, the device disclosed in Patent Literature 1 determines that the position of a light acoustic medium unit having sensed anomalous sound is the generation position of the anomalous sound, and accordingly, the position of the sound source of the anomalous sound can be identified only when the sound source is located on an optical fiber.

Thus, a problem with the device disclosed in Patent Literature 1 is that it cannot identify the position of a sound source when the sound source is located at a place away from an optical fiber.

An object of the present disclosure is to solve the above-described problem and provide an optical fiber sensing system and a sound source position identification method that are capable of identifying the position of a sound source located at a place away from an optical fiber.

### Solution to Problem

An optical fiber sensing system according to an aspect includes:

an optical fiber disposed to lie in a plurality of directions and configured to sense sound generated in a monitored area;

a reception unit configured to receive, from the optical fiber, an optical signal on which the sound is superimposed; and

an identification unit configured to analyze distribution of the sound sensed by the optical fiber based on the optical signal and identify a generation position of the sound based on the analyzed distribution of the sound.

A sound source position identification method according to an aspect includes:

a step of sensing, by an optical fiber disposed to lie in a plurality of directions, sound generated in a monitored area;

a step of receiving, from the optical fiber, an optical signal on which the sound is superimposed; and

an identification step of analyzing distribution of the sound sensed by the optical fiber based on the optical signal and identifying a generation position of the sound based on the analyzed distribution of the sound.

### Advantageous Effects of Invention

According to the above-described aspects, it is possible to provide an optical fiber sensing system and a sound source position identification method that are capable of identifying the position of a sound source located at a place away from an optical fiber.

### BRIEF DESCRIPTION OF THE DRAWINGS

FIG. 1 is a diagram illustrating an exemplary configuration of an optical fiber sensing system according to a first example embodiment.

FIG. 2 is a diagram illustrating exemplary arrangement of an optical fiber according to the first example embodiment.

FIG. 3 is a diagram illustrating exemplary arrangement of the optical fiber according to the first example embodiment.

FIG. 4 is a diagram illustrating an exemplary configuration of an identification unit according to the first example embodiment.

FIG. 5 is a diagram illustrating exemplary acoustic data of sound sensed by the optical fiber according to the first example embodiment.

FIG. 6 is a diagram illustrating an example in which the identification unit according to the first example embodiment determines, by using pattern matching, whether sound sensed by an optical fiber is monitoring target sound.

FIG. 7 is a diagram illustrating an exemplary method by which the identification unit according to the first example embodiment identifies the generation position of monitoring target sound.

FIG. 8 is a diagram illustrating another exemplary method by which the identification unit according to the first example embodiment identifies the generation position of monitoring target sound.

FIG. 9 is a flowchart illustrating exemplary operation of the optical fiber sensing system according to the first example embodiment.

FIG. 10 is a diagram illustrating an exemplary configuration of identification unit according to a second example embodiment.

FIG. 11 is a diagram illustrating an exemplary method by which an identification unit according to the second example embodiment identifies the generation area of monitoring target sound.

FIG. 12 is a diagram illustrating an exemplary method by which the identification unit according to the second example embodiment identifies the generation area of monitoring target sound.

FIG. 13 is a diagram illustrating an exemplary method by which the identification unit according to the second example embodiment identifies the generation area of monitoring target sound.

FIG. 14 is a diagram illustrating an exemplary method by which the identification unit according to the second example embodiment identifies the generation area of monitoring target sound.

FIG. 15 is a flowchart illustrating exemplary operation of an optical fiber sensing system according to the second example embodiment.

FIG. 16 is a diagram illustrating an exemplary configuration of an identification unit according to a third example embodiment.

FIG. 17 is a diagram illustrating an exemplary method by which the identification unit according to the third example embodiment identifies the movement locus of a monitoring target.

FIG. 18 is a diagram illustrating an exemplary method by which the identification unit according to the third example embodiment identifies the movement locus of a monitoring target.

FIG. 19 is a flowchart illustrating exemplary operation of an optical fiber sensing system according to the third example embodiment.

FIG. 20 is a diagram illustrating an exemplary method by which the identification unit according to the third example embodiment identifies the movement locus of a monitoring target.

FIG. 21 is a diagram illustrating an exemplary method by which the identification unit according to the third example embodiment identifies the movement locus of a monitoring target.

FIG. 22 is a diagram illustrating an exemplary configuration of an optical fiber sensing system according to a fourth example embodiment.

FIG. 23 is a diagram illustrating an exemplary GUI screen that a report unit according to the fourth example embodiment uses for reporting.

FIG. 24 is a diagram illustrating an exemplary GUI screen that the report unit according to the fourth example embodiment uses for reporting.

FIG. 25 is a diagram illustrating an exemplary GUI screen that the report unit according to the fourth example embodiment uses for reporting.

FIG. 26 is a diagram illustrating an exemplary GUI screen that the report unit according to the fourth example embodiment uses for reporting.

FIG. 27 is a diagram illustrating an exemplary movement locus identified by an identification unit according to the fourth example embodiment.

FIG. 28 is a diagram illustrating an exemplary GUI screen that the report unit according to the fourth example embodiment uses for reporting.

FIG. 29 is a diagram illustrating an exemplary movement locus identified by the identification unit according to the fourth example embodiment.

FIG. 30 is a diagram illustrating an exemplary GUI screen that the report unit according to the fourth example embodiment uses for reporting.

FIG. 31 is a flowchart illustrating exemplary operation of the optical fiber sensing system according to the fourth example embodiment.

FIG. 32 is a block diagram illustrating an exemplary hardware configuration of a computer that achieves an optical fiber sensing instrument.

### DESCRIPTION OF EMBODIMENTS

Example embodiments of the present disclosure will be described below with reference to the accompanying drawings. Note that the following description and drawings include omission and simplification as appropriate for clarification of explanation. Identical elements in the drawings described below are denoted by the same reference sign, and duplicate description thereof omitted as necessary.

### First Example Embodiment

First, an exemplary configuration of an optical fiber sensing system according to the present first example embodiment will be described below with reference to FIG. 1.

As illustrated in FIG. 1, the optical fiber sensing system according to the present first example embodiment includes an optical fiber 10, a reception unit 20, and an identification unit 30.

The optical fiber 10 is disposed in a monitoring target area. Possible monitoring target areas include, for example, a nursery school, an animal rearing facility, a theme park, a prison, an airport, and their nearby places, but the present disclosure is not limited thereto. When the monitoring target area is outdoor, the optical fiber 10 may be embedded in the ground, bonded to the ground, or wired overhead with utility poles or the like. When the monitoring target area is indoor, the optical fiber 10 may be bonded to or embedded in a floor, a wall, a ceiling, or the like.

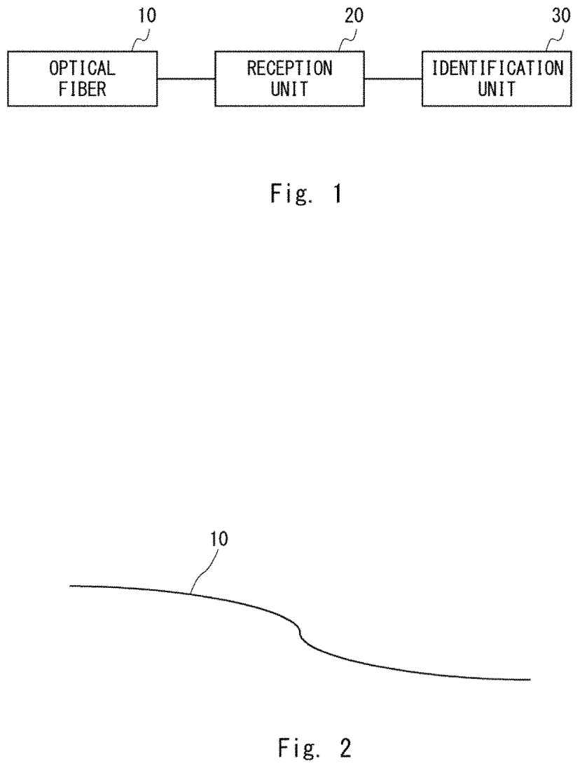

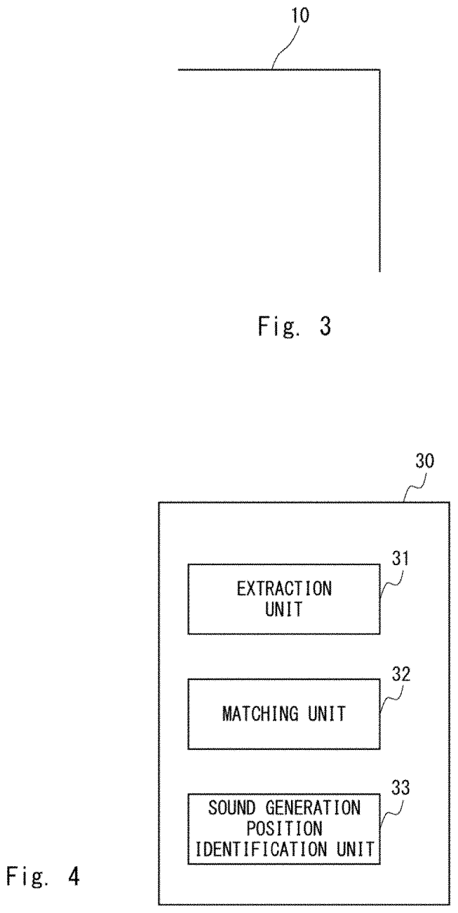

The optical fiber 10 is disposed to lie in a plurality of directions in the monitoring target area. For example, when disposed in a curved line shape as illustrated in FIG. 2, the optical fiber 10 naturally lies in a plurality of directions. When disposed being bent at one or more locations as illustrated in FIG. 3, as well, the optical fiber 10 naturally lies in a plurality of directions. However, the present disclosure is not limited to the examples of FIGS. 2 and 3, and the optical fiber 10 may lie in a plurality of directions in a manner other than those in FIGS. 2 and 3.

Only one optical fiber 10 may be provided, or a plurality of optical fibers 10 may be provided. When a plurality of optical fibers 10 are provided, one reception unit 20 may be provided to the plurality of optical fibers 10, or a plurality of reception units 20 corresponding to the plurality of respective optical fibers 10 may be provided.

The reception unit 20 inputs pulse light to the optical fiber 10. The reception unit 20 receives, as returning light through the optical fiber 10, reflected light and scattering ray generated as the pulse light is transmitted through the optical fiber 10.

When sound is generated around the optical fiber 10, the optical fiber 10 swings (deforms) by vibration of the sound, and accordingly, the wavelength of returning light transmitted through the optical fiber 10 changes. In other words, sound generated around the optical fiber 10 is superimposed on returning light transmitted through the optical fiber 10. In this manner, the optical fiber 10 can sense sound generated around the optical fiber 10.

Thus, when sound is generated around the optical fiber 10, the optical fiber 10 senses the sound, superimposes the sound on returning light, and transmits the returning light, and the reception unit 20 receives the returning light on which the sound sensed by the optical fiber 10 is superimposed.

However, when sound is generated around the optical fiber 10, the wavelength of returning light changes at not one point but a plurality of points on the optical fiber 10. Thus, the optical fiber 10 senses the sound at the plurality of points on the optical fiber 10. In this case, the intensity of the sound sensed at each of the plurality of points on the optical fiber 10 and the time of sensing of the sound are different between the plurality of points in accordance with the positional relation between the sound source position of the sound and each of the plurality of points.

Thus, the identification unit 30 analyzes distribution of sound sensed by the optical fiber 10 (the intensity of sensed sound and the time of sensing of the sound) based on returning light received by the reception unit 20, and identifies the generation position of the sound based on the analyzed distribution of the sound.

The identification unit 30 will be described below in detail.

Note that the following description is made with an example in which the identification unit 30 identifies the generation position of sound (hereinafter referred to as monitoring target sound) corresponding to a monitoring target registered to the identification unit 30 in advance among sound generated around the optical fiber 10. However, the present disclosure is not limited thereto, and the identification unit 30 may identify the generation position of sound other than the monitoring target sound. The monitoring target is, for example, a shooting person, a screaming person, or a person wandering in a predetermined area. In these cases, the monitoring target sound is gunshot sound, scream sound, or footstep sound, respectively. However, the monitoring target and the monitoring target sound are not limited thereto.

First, an exemplary configuration of the identification unit 30 according to the present first example embodiment will be described below with reference to FIG. 4.

As illustrated in FIG. 4, the identification unit 30 according to the present first example embodiment includes an extraction unit 31, a matching unit 32, and a sound generation position identification unit 33.

The extraction unit 31 extracts the component of sound sensed at a sensing point from returning light received by the reception unit 20. In the present first example embodiment, sound sensed at three or more sensing points on the optical fiber 10 is used to identify the generation position of the sound. Thus, the extraction unit 31 extracts the component of sound sensed at each of the three or more sensing points.

The time difference between a time at which the reception unit 20 inputs pulse light to the optical fiber 10 and a time at which returning light on which sound is superimposed is received by the reception unit 20 is determined in accordance with a position (distance of the optical fiber 10 from the reception unit 20) at which the sound is sensed on the optical fiber 10. Thus, for example, the extraction unit 31 holds, for each of three or more sensing points on the optical fiber 10, information of the time difference in accordance with the position of the sensing point so that it is possible to determine whether returning light received by the reception unit 20 is returning light on which sound sensed at the sensing point is superimposed. Thus, the extraction unit 31 extracts the component of sound sensed at a sensing point from returning light on which the sound is determined to be superimposed.

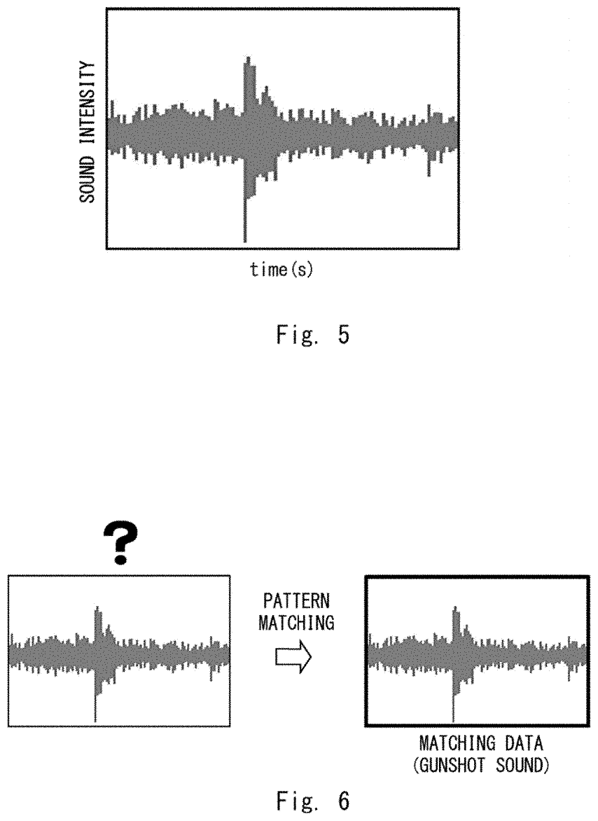

The matching unit 32 determines whether sound sensed at a sensing point and extracted by the extraction unit 31 is the monitoring target sound corresponding to the monitoring target registered in advance. The determination may use, for example, pattern matching. For example, the matching unit 32 converts, by using a distributed acoustic sensor, sound extracted by the extraction unit 31 into acoustic data as illustrated in FIG. 5. The acoustic data illustrated in FIG. 5 is acoustic data of sound sensed at a sensing point with the horizontal axis representing time and the vertical axis representing sound intensity. Matching data of the monitoring target sound is prepared in advance. Note that the matching data may be held inside or outside the identification unit 30. Then, as illustrated in FIG. 6, the matching unit 32 compares a pattern included in the converted acoustic data with a pattern included in the matching data of the monitoring target sound. When the pattern included in the converted acoustic data matches a pattern included in the matching data of the monitoring target sound, the matching unit 32 determines that the converted acoustic data is acoustic data of the monitoring target sound. FIG. 6 corresponds to an example in which the monitoring target sound is gunshot sound. In the example illustrated in FIG. 6, the converted acoustic data substantially matches acoustic data of gunshot sound in pattern. Thus, the matching unit 32 determines that the sound sensed at the sensing point is the monitoring target sound (gunshot sound).

When the sound sensed at the sensing point is the monitoring target sound, the matching unit 32 passes acoustic data of the monitoring target sound sensed at the sensing point to the sound generation position identification unit 33.

The sound generation position identification unit 33 analyzes distribution (the intensity of sensed sound and the time of sensing of the sound) of the monitoring target sound sensed at three or more sensing points based on the acoustic data of the monitoring target sound sensed at three or more sensing points on the optical fiber 10, and identifies the generation position of the monitoring target sound based on the analyzed distribution of the monitoring target sound.

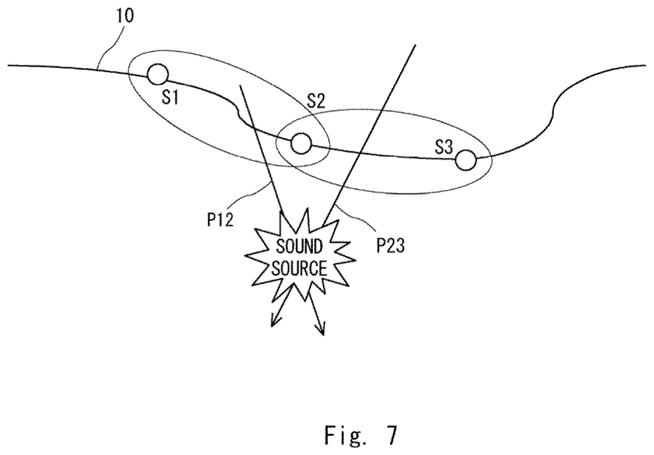

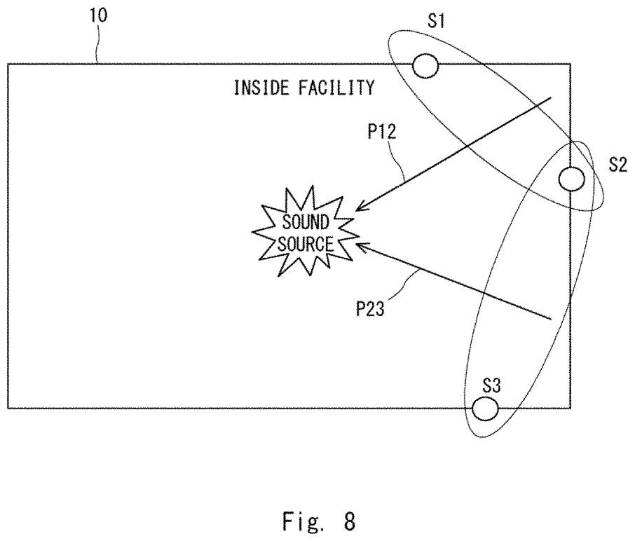

Subsequently, an overview of a method by which the sound generation position identification unit 33 identifies the generation position of the monitoring target sound will be described below with reference to FIGS. 7 and 8.

In an example illustrated in FIG. 7, an optical fiber 10 is disposed in a curved line shape, and three sensing points S1 to S3 are provided on the optical fiber 10. Note that this is merely exemplary, and three or more sensing points may be provided on the optical fiber 10. First, the sound generation position identification unit 33 selects two optional sensing points. In this example, the sensing points S1 and S2 are selected. Then, the sound generation position identification unit 33 derives the intensity difference and time difference of the monitoring target sound sensed at the two sensing points S1 and S2 based on distribution (intensity and time) of the monitoring target sound sensed at the two sensing points S1 and S2, and estimates the generation position of the monitoring target sound based on the derived intensity difference and time difference. In this example, the generation position of the monitoring target sound is estimated to be a position on a line P12. Subsequently, the identification unit 30 selects two sensing points in a combination different from that of the two points selected above. In this example, the sensing points S2 and S3 are selected. Then, in the same manner as described above, the sound generation position identification unit 33 estimates the generation position of the monitoring target sound based on distribution (intensity and time) of the monitoring target sound sensed at the two sensing points S2 and S3. In this example, the generation position of the monitoring target sound is estimated to be a position on a line P23. Then, the sound generation position identification unit 33 identifies, as the generation position of the monitoring target sound, a position at which the lines P12 and P23 intersect each other.

In an example illustrated in FIG. 8, an optical fiber 10 is disposed in a rectangular shape around a facility as the monitoring target area, and three sensing points S1 to S3 are provided on three different sides, respectively, of the rectangle on the optical fiber 10. Note that this is merely exemplary, and three or more sensing points may be provided on the optical fiber 10. In the example illustrated in FIG. 8 as well, the generation position of the monitoring target sound is identified by a method same as that of FIG. 7. Specifically, first, the sound generation position identification unit 33 estimates the generation position of the monitoring target sound (in this example, the generation position is estimated to be a position on the line P12) based on distribution (intensity and time) of the monitoring target sound sensed at two optional sensing points (in this example, the sensing points S1 and S2). Subsequently, the sound generation position identification unit 33 estimates the generation position of the monitoring target sound (in this example, the generation position is estimated to be a position on the line P23) based on distribution (intensity and time) of the monitoring target sound sensed at two sensing points (in this example, the sensing points S2 and S3) in a combination different from that of the two points selected above. Then, the sound generation position identification unit 33 identifies, as the generation position of the monitoring target sound, a position at which the lines P12 and P23 intersect each other.

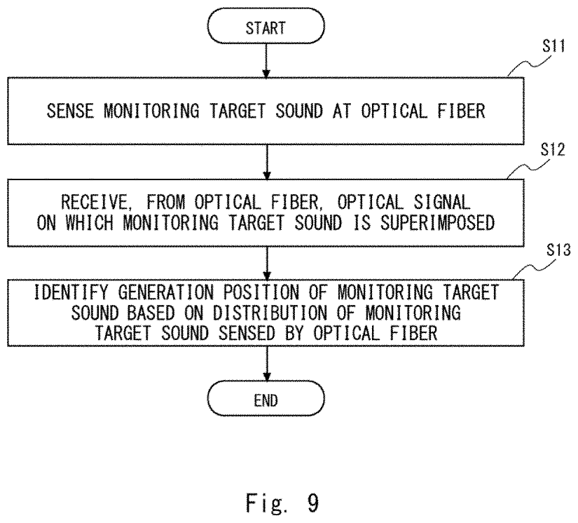

Subsequently, exemplary operation of the optical fiber sensing system according to the present first example embodiment will be described below with reference to FIG. 9.

As illustrated in FIG. 9, an optical fiber 10 senses the monitoring target sound generated around the optical fiber 10 (step S11). The monitoring target sound is transmitted in superimposition on returning light transmitted through the optical fiber 10.

Subsequently, the reception unit 20 receives, from the optical fiber 10, the returning light on which the monitoring target sound sensed by the optical fiber 10 is superimposed (step S12).

Thereafter, the identification unit 30 analyzes distribution of the monitoring target sound sensed by the optical fiber 10 based on the returning light received by the reception unit 20 and identifies the generation position of the monitoring target sound based on the analyzed distribution of the monitoring target sound (step S13). In this case, the identification unit 30 may identify the generation position of the monitoring target sound by using, for example, the above-described methods in FIGS. 7 and 8.

According to the present first example embodiment as described above, the reception unit 20 receives, from an optical fiber 10, returning light on which sound sensed by the optical fiber 10 is superimposed. The identification unit 30 analyzes distribution of the sound sensed by the optical fiber 10 based on the received returning light and identifies the generation position of the sound based on the analyzed distribution of the sound. Accordingly, the position of a sound source can be identified even when the sound source is located at a place away from the optical fiber 10.

### Second Example Embodiment

An optical fiber sensing system according to the present second example embodiment has a system configuration same as that in the first example embodiment described above, but the identification unit 30 has an extended function.

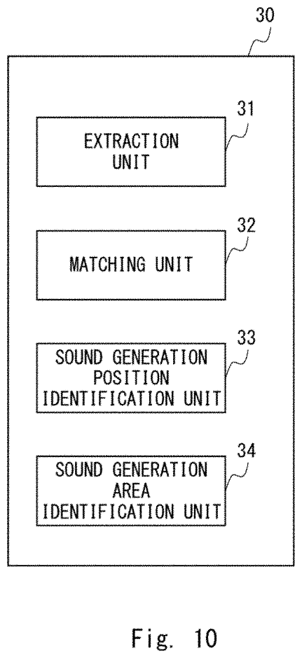

Thus, an exemplary configuration of the identification unit 30 according to the present second example embodiment will be described below with reference to FIG. 10.

As illustrated in FIG. 10, the identification unit 30 according to the present second example embodiment additionally includes a sound generation area identification unit 34, which is a difference from the configuration in FIG. 4 according to the first example embodiment described above.

The sound generation area identification unit 34 identifies a generation area in which the monitoring target sound is generated. For example, the sound generation area identification unit 34 identifies whether the generation area of the monitoring target sound is inside or outside the monitoring target area. Alternatively, when the inside of the monitoring target area is divided into a plurality of areas, the sound generation area identification unit 34 identifies which area inside the monitoring target area is the generation area of the monitoring target sound.

The sound generation area identification unit 34 may identify the generation area of the monitoring target sound based on the generation position of the monitoring target sound, which is identified by the sound generation position identification unit 33. In this case, for example, the sound generation area identification unit 34 may preliminarily store a correspondence table in which a position identified by the sound generation position identification unit 33 is associated with an area, and may identify the generation area of the monitoring target sound from the generation position of the monitoring target sound, which is identified by the sound generation position identification unit 33, by using the correspondence table.

However, when two or more optical fibers 10 are disposed substantially in parallel, the sound generation area identification unit 34 can identify which of areas partitioned by the two or more optical fibers 10 is the generation area of the monitoring target sound without using the generation position of the monitoring target sound, which is identified by the sound generation position identification unit 33. In this case, the sound generation area identification unit 34 analyzes distribution (the intensity of the sensed sound and the time of sensing of the sound) of the monitoring target sound sensed at sensing points on the two or more optical fibers 10, and identifies the generation area of the monitoring target sound based on the analyzed distribution of the monitoring target sound. Note that when the generation area of the monitoring target sound is identified in this manner, the two or more optical fibers 10 only need to be disposed substantially in parallel and each do not necessarily need to be disposed to lie in a plurality of directions as in a case of identifying the generation position of the monitoring target sound.

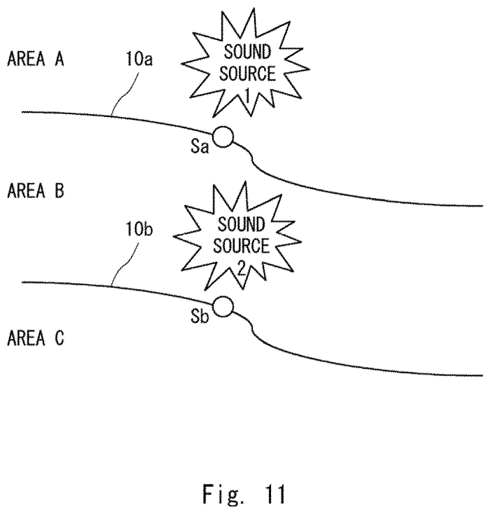

An overview of a method by which the sound generation area identification unit 34 identifies the generation area of the monitoring target sound based on distribution of the monitoring target sound will be described below with reference to FIGS. 11 to 14.

In an example of FIG. 11, two optical fibers 10a and 10b are disposed in curved line shapes and substantially in parallel. Note that this is merely exemplary, and the two or more optical fibers 10 only need to be disposed substantially in parallel. The optical fiber 10a is disposed at the boundary between areas A and B, and the optical fiber 10b is disposed at the boundary between areas B and C. Sensing points Sa and Sb are provided on the two optical fibers 10a and 10b, respectively. The sound generation area identification unit 34 derives the intensity difference and time difference of the monitoring target sound sensed at the two sensing points Sa and Sb based on distribution (intensity and time) of the monitoring target sound sensed at the two sensing points Sa and Sb. For example, when the sound source of the monitoring target sound is a sound source 1 in the area A, the monitoring target sound is sensed at the sensing point Sa earlier than at the sensing point Sb, and the intensity of the sensed monitoring target sound is higher at the sensing point Sa than at the sensing point Sb. Thus, when such sensing is performed with the sensing points Sa and Sb, the sound generation area identification unit 34 identifies that the generation area of the monitoring target sound is the area A. When the sound source of the monitoring target sound is a sound source 2 in an area BA, the time difference in sensing of the monitoring target sound is small between the sensing points Sa and Sb, and the intensity of the sensed monitoring target sound is substantially same therebetween. Thus, when such sensing is performed with the sensing points Sa and Sb, the sound generation area identification unit 34 identifies that the generation area of the monitoring target sound is the area B.

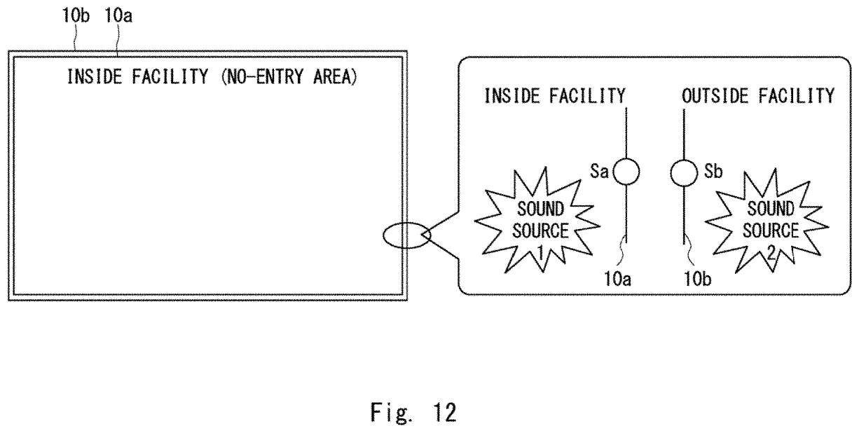

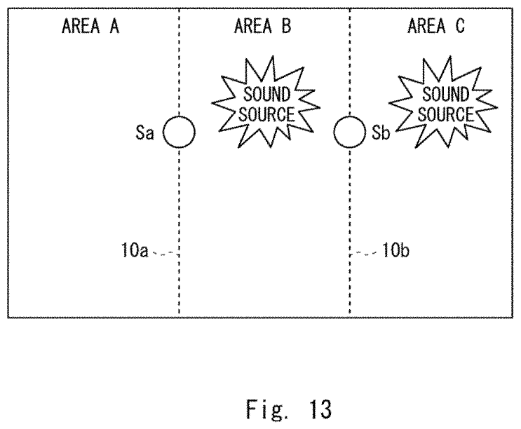

In an example of FIG. 12, two optical fibers 10a and 10b are disposed substantially in parallel in a rectangular shape around a facility as the monitoring target area. In other words, the two optical fibers 10a and 10b are disposed at the boundary between the inside and outside of the facility. Sensing points Sa and Sb are provided on the two optical fibers 10a and 10b, respectively. In the example of FIG. 12, the method of identifying the generation area of the monitoring target sound is same as that for FIG. 11. Specifically, the sound generation area identification unit 34 derives the intensity difference and time difference of the monitoring target sound sensed by the two sensing points Sa and Sb. For example, when the sound source of the monitoring target sound is a sound source 1 inside the facility, the monitoring target sound is sensed at the sensing point Sa earlier than at the sensing point Sb, and the intensity of the sensed monitoring target sound is higher at the sensing point Sa than at the sensing point Sb. Thus, when such sensing is performed with the sensing points Sa and Sb, the sound generation area identification unit 34 identifies that the generation area of the monitoring target sound is inside the facility (in other words, inside the monitoring target area). When the sound source of the monitoring target sound is a sound source 2 outside the facility, the monitoring target sound is sensed at the sensing point Sb earlier than at the sensing point Sa, and the intensity of the sensed monitoring target sound is higher at the sensing point Sb than at the sensing point Sa. Thus, when such sensing is performed with the sensing points Sa and Sb, the sound generation area identification unit 34 identifies that the generation area of the monitoring target sound is outside the facility (in other words, outside the monitoring target area).

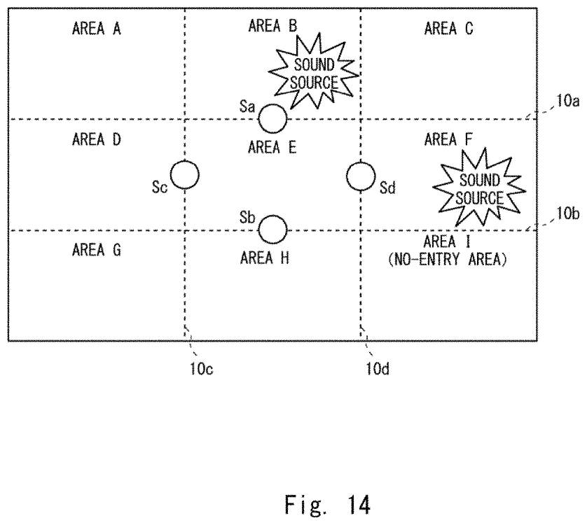

In examples of FIGS. 13 and 14, optical fibers 10 are disposed inside the monitoring target area and divide the inside of the monitoring target area into a plurality of areas.

In the example of FIG. 13, two optical fibers 10a and 10b are disposed substantially in parallel in one axial direction and divide the inside of the monitoring target area into three areas A to C. Sensing points Sa and Sb are provided on the two optical fibers 10a and 10b, respectively.

In the example of FIG. 14, four optical fibers 10a to 10d are disposed in two axial directions and divide the inside of the monitoring target area into nine areas A to I of a matrix. Specifically, the two optical fibers 10a and 10b are disposed substantially in parallel in an axial direction, and the two optical fibers 10c and 10d are disposed substantially in parallel in an axial direction substantially orthogonal to the two optical fibers 10a and 10b. Sensing points Sa to Sd are provided on the four optical fibers 10a to 10d, respectively. The sensing points Sa to Sd are disposed near the center of the optical fibers 10a to 10d.

In the example of FIG. 13, the method of identifying the generation area of the monitoring target sound is same as that for FIG. 11. In the example of FIG. 14, the method of identifying the generation area of the monitoring target sound is same as that for FIG. 11 except that the number of sensing points is different. Specifically, for example, in the example of FIG. 14, the sound generation area identification unit 34 derives the intensity difference and time difference of the monitoring target sound sensed by the four sensing points Sa to Sd. For example, when the sound source of the monitoring target sound is in the area B, the monitoring target sound is sensed at the sensing point Sa earlier than at the sensing point Sb, and the intensity of the sensed monitoring target sound is higher at the sensing point Sa than at the sensing point Sb. The time difference in sensing of the monitoring target sound is small between the sensing points Sc and

Sd, and the intensity of the sensed monitoring target sound is substantially same therebetween. Thus, when such sensing is performed with the sensing points Sa to Sd, the sound generation area identification unit 34 identifies that the generation area of the monitoring target sound is the area B.

When optical fibers 10 are disposed inside the monitoring target area in this manner, it is possible to divide the inside of the monitoring target area into a plurality of areas and identify which of the plurality of areas is the generation area of the monitoring target sound. The area division can be flexibly performed by changing an installation manner of optical fibers, set positions of sensing points, and the like. Thus, when the monitoring target area includes a predetermined area such as a no-entry area or a dangerous area, generation of the monitoring target sound in the predetermined area or an area adjacent to the predetermined area can be identified by disposing optical fibers 10 in accordance with the predetermined area. Accordingly, for example, entry to the predetermined area can be sensed.

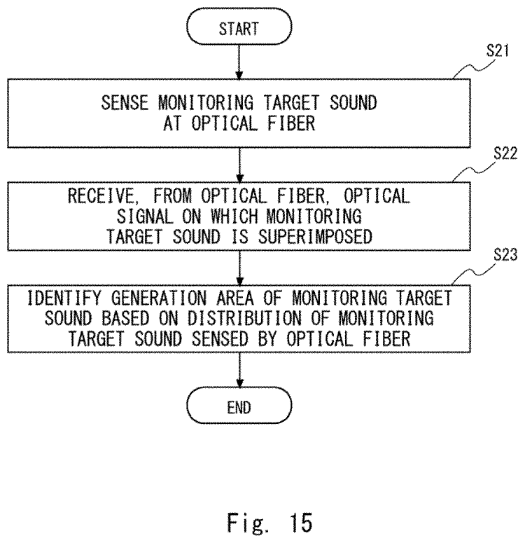

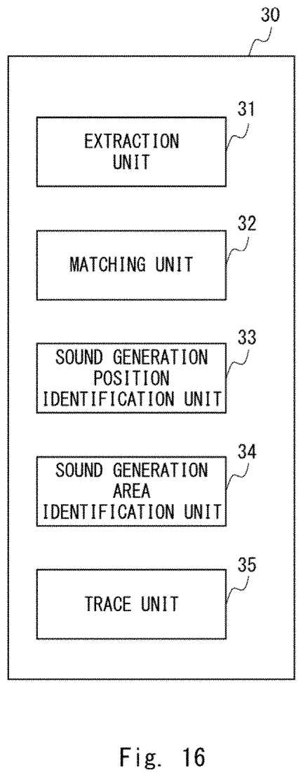

Subsequently, exemplary operation of the optical fiber sensing system according to the present second example embodiment will be described below with reference to FIG. 15.

As illustrated in FIG. 15, an optical fiber 10 senses the monitoring target sound generated around the optical fiber 10 (step S21). The monitoring target sound is transmitted in superimposition on returning light transmitted through the optical fiber 10.

Subsequently, the reception unit 20 receives, from the optical fiber 10, the returning light on which the monitoring target sound sensed by the optical fiber 10 is superimposed (step S22).

Thereafter, the identification unit 30 analyzes distribution of the monitoring target sound sensed by the optical fiber 10 based on the returning light received by the reception unit 20 and identifies the generation area of the monitoring target sound based on the analyzed distribution of the monitoring target sound (step S23). In this case, the identification unit 30 may identify the generation area of the monitoring target sound by using, for example, the above-described methods in FIGS. 11 to 14.

Note that FIG. 15 may additionally include a step in which the identification unit 30 identifies the generation position of the monitoring target sound based on distribution of the monitoring target sound. In this case, at step S23, the identification unit 30 may identify the generation area of the monitoring target sound based on the generation position of the monitoring target sound.

According to the present second example embodiment as described above, the reception unit 20 receives, from an optical fiber 10, returning light on which sound sensed by the optical fiber 10 is superimposed. The identification unit 30 analyzes distribution of the sound sensed by the optical fiber 10 based on the received returning light and identifies the generation area of the sound based on the analyzed distribution of the sound. Alternatively, the identification unit 30 identifies the generation position of the sound based on the distribution analyzed of the sound and identifies the generation area of the sound based on the identified generation position. Accordingly, the area of a sound source can be identified even when the sound source is located at a place away from the optical fiber 10.

### Third Example Embodiment

An optical fiber sensing system according to the present third example embodiment has a system configuration same as those in the first and second example embodiments described above, but the identification unit 30 has an extended function.

Thus, an exemplary configuration of the identification unit 30 according to the present third example embodiment will be described below with reference to FIG. 16.

As illustrated in FIG. 16, the identification unit 30 according to the present third example embodiment additionally includes a trace unit 35, which is a difference from the configuration in FIG. 10 according to the second example embodiment described above.

The sound generation position identification unit 33 repeats identification of the generation position of the monitoring target sound. The sound generation position identification unit 33 may identify the generation position of the monitoring target sound at optional timings, and the timings may be periodic or non-periodic. The sound generation position identification unit 33 may repeat identification of the generation position of the monitoring target sound until a certain duration elapses or until the identification is performed a certain number of times.

The trace unit 35 identifies the movement locus of the monitoring target based on time-series change of the generation position of the monitoring target sound, which is identified by the sound generation position identification unit 33. For example, when the monitoring target sound is footstep sound of a person wandering in a predetermined area, the sound generation position identification unit 33 repeats identification of the generation position of footstep sound of the person, and the trace unit 35 identifies the movement locus of the person based on time-series change of the generation position of footstep sound of the person.

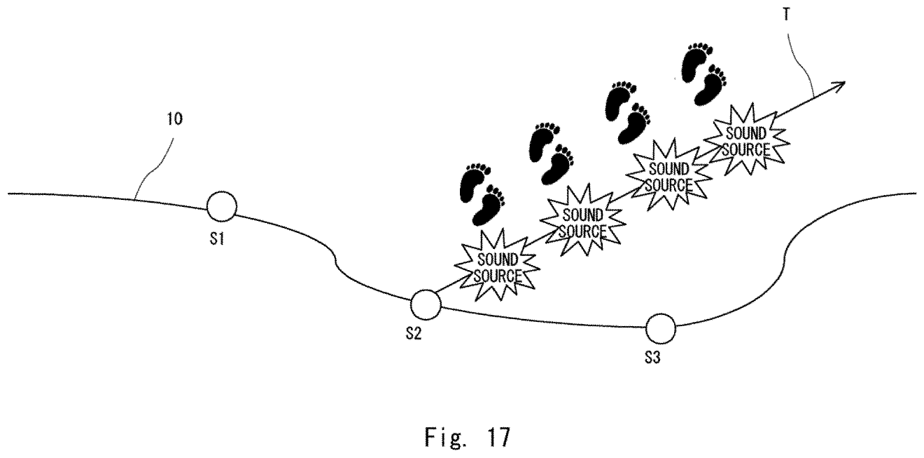

For example, in an example illustrated in FIG. 17, the sound generation position identification unit 33 repeats identification of the generation position of the monitoring target sound by a method same as that for the above-described example illustrated in FIG. 7. Thus, the trace unit 35 identifies a movement locus T of the monitoring target based on time-series change of the generation position of the monitoring target sound.

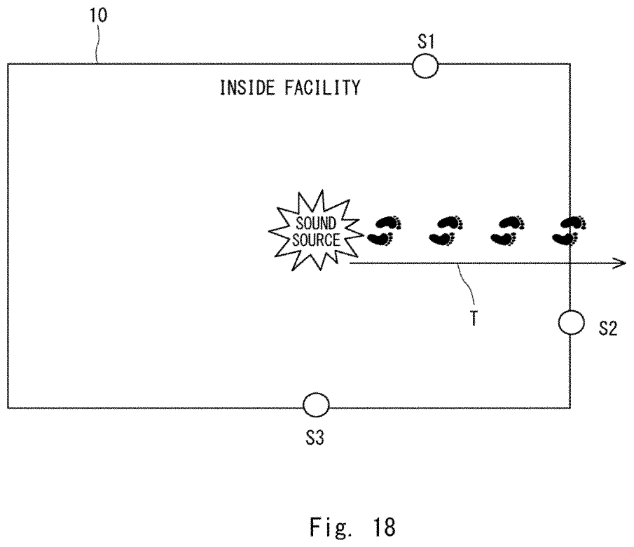

In an example illustrated in FIG. 18, the sound generation position identification unit 33 repeats identification of the generation position of the monitoring target sound by a method same as that for the above-described example illustrated in FIG. 8. Thus, the trace unit 35 identifies the movement locus T of the monitoring target based on time-series change of the generation position of the monitoring target sound. In the example illustrated in FIG. 18, the movement locus T of the monitoring target indicates that the monitoring target has moved from the inside of a facility to the outside thereof.

The sound generation position identification unit 33 potentially becomes unable to identify the generation position of the monitoring target sound before a certain duration elapses or before the identification is performed a certain number of times. The generation position of the monitoring target sound cannot be identified, for example, when the monitoring target sound cannot be sensed by optical fibers 10 because the monitoring target has moved away from the optical fibers 10 or the monitoring target sound has become mixed with other sound. In such a case, the trace unit 35 may estimate a direction and a position where the monitoring target moves next based on an already identified movement locus of the monitoring target.

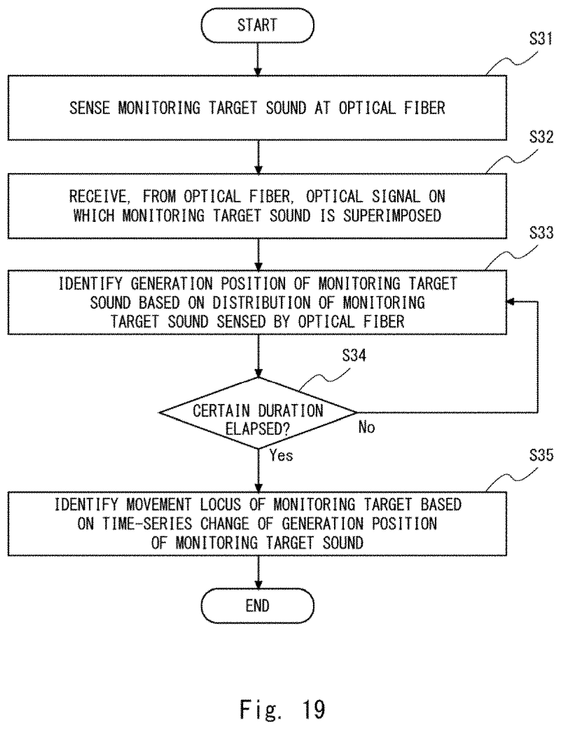

Subsequently, exemplary operation of the optical fiber sensing system according to the present third example embodiment will be described below with reference to FIG. 19. In the following description, it is assumed that the identification unit 30 repeats identification of the generation position of the monitoring target sound until a certain duration elapses.

As illustrated in FIG. 19, an optical fiber 10 senses the monitoring target sound generated around the optical fiber 10 (step S31). The monitoring target sound is transmitted in superimposition on returning light transmitted through the optical fiber 10.

Subsequently, the reception unit 20 receives, from the optical fiber 10, the returning light on which the monitoring target sound sensed by the optical fiber 10 is superimposed (step S32).

Subsequently, the identification unit 30 analyzes distribution of the monitoring target sound sensed by the optical fiber 10 based on the returning light received by the reception unit 20 and identifies the generation position of the monitoring target sound based on the analyzed distribution of the monitoring target sound (step S33). In this case, the identification unit 30 may identify the generation position of the monitoring target sound by using, for example, the above-described methods in FIGS. 7 and 8.

The identification unit 30 repeats identification of the generation position of the monitoring target sound until a certain duration elapses (step S34). Specifically, when the certain duration has not elapsed since the generation position of the monitoring target sound is identified for the first time (No at step S34), the identification unit 30 returns to step S33 and performs identification of the generation position of the monitoring target sound.

Thereafter, the identification unit 30 identifies the movement locus of the monitoring target based on time-series change of the generation position of the monitoring target sound, which is identified as described above (step S35). In this case, the identification unit 30 may identify the movement locus of the monitoring target by using, for example, the above-described methods in FIGS. 17 and 18.

Note that, in FIG. 19, the identification unit 30 identifies the movement locus of the monitoring target after the certain duration has elapsed, but the present disclosure is not limited thereto. The identification unit 30 can identify the movement locus of the monitoring target when the generation position of the monitoring target sound is determined at two or more locations. Thus, the identification unit 30 may identify the movement locus of the monitoring target before the certain duration elapses.

FIG. 19 may additionally include a step in which the identification unit 30 identifies the generation area of the monitoring target sound. In this case, the identification unit 30 may identify the generation area of the monitoring target sound based on distribution of the monitoring target sound or based on the generation position of the monitoring target sound.

According to the present third example embodiment as described above, the identification unit 30 repeats identification of the generation position of the monitoring target sound and identifies the movement locus of the monitoring target based on time-series change of the generation position of the monitoring target sound. Accordingly, the monitoring target can be traced.

Note that, in the present third example embodiment, the sound generation position identification unit 33 repeats identification of the generation position of the monitoring target sound, and the trace unit 35 identifies the movement locus of the monitoring target based on time-series change of the generation position of the monitoring target sound, but the present disclosure is not limited thereto.

For example, the sound generation area identification unit 34 may repeat identification of the generation area of the monitoring target sound, and the trace unit 35 may identify the movement locus of the monitoring target based on time-series change of the generation area of the monitoring target sound.

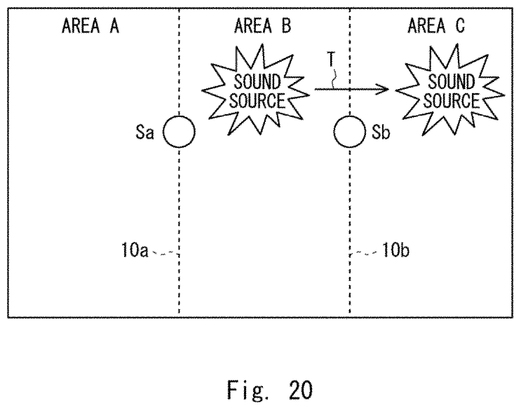

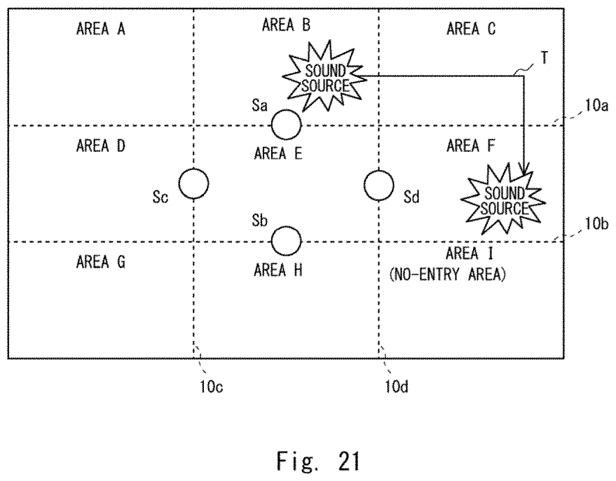

For example, in an example illustrated in FIG. 20, the sound generation area identification unit 34 repeats identification of the generation area of the monitoring target sound by a method same as that in the above-described example of FIG. 13. Thus, the trace unit 35 identifies the movement locus T of the monitoring target based on time-series change of the generation area of the monitoring target sound. In the example illustrated in FIG. 20, the movement locus T of the monitoring target indicates that the monitoring target has moved from an area B to an area C.

In an example illustrated in FIG. 21, the sound generation area identification unit 34 repeats identification of the generation area of the monitoring target sound by a method same as that in the above-described example of FIG. 14. Thus, the trace unit 35 identifies the movement locus T of the monitoring target based on time-series change of the generation area of the monitoring target sound. In the example illustrated in FIG. 21, the movement locus T of the monitoring target indicates that the monitoring target has moved from an area B to an area F through an area C.

### Fourth Example Embodiment

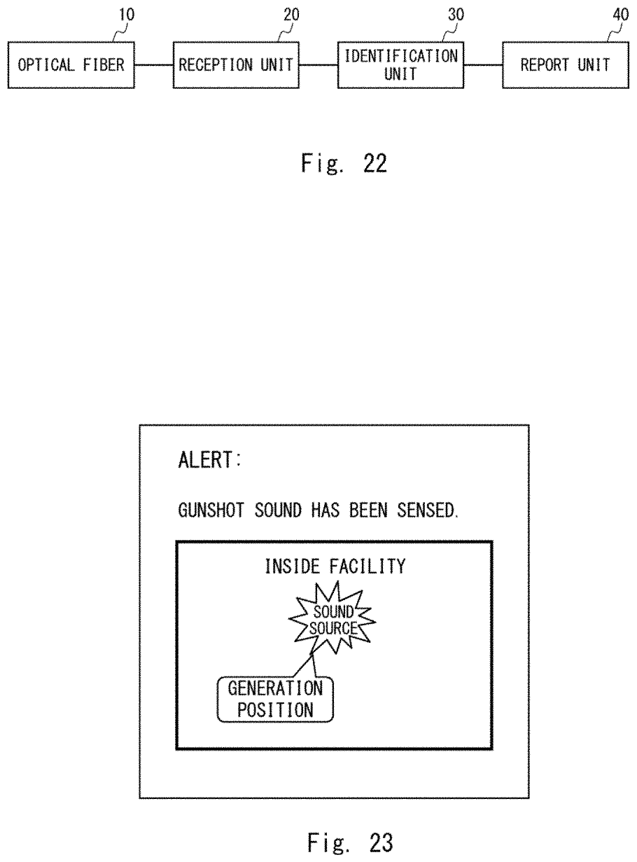

First, an exemplary configuration of an optical fiber sensing system according to the present fourth example embodiment will be described below with reference to FIG. 22.

As illustrated in FIG. 22, the optical fiber sensing system according to the present fourth example embodiment additionally includes a report unit 40, which is a difference from the configuration in FIG. 1 according to the first to third example embodiments described above.

The report unit 40 determines whether a predetermined event has occurred based on the generation position or generation area of the monitoring target sound and the movement locus of the monitoring target, which are identified by the identification unit 30, and performs reporting when the predetermined event has occurred. The destination of the reporting may be, for example, a monitoring system or monitoring room that monitors the monitoring target area. The reporting may be performed by, for example, a method of displaying a graphical user interface (GUI) screen on a display or a monitor at the reporting destination, or a method of outputting a voice message from a speaker at the reporting destination.

Note that the identification unit 30 according to the present fourth example embodiment may be any of the configurations in FIGS. 4, 10, and 16 according to the first to third example embodiments described above.

Exemplary specific reporting by the report unit 40 will be described below. For example, when danger indicating sound such as gunshot sound or scream sound is sensed as the monitoring target sound, the report unit 40 may report the generation position or generation area of the monitoring target sound, which is identified by the identification unit 30. FIG. 23 illustrates an example in which this reporting is performed on a GUI screen. FIG. 23 illustrates an exemplary GUI screen when the monitoring target sound is gunshot sound.

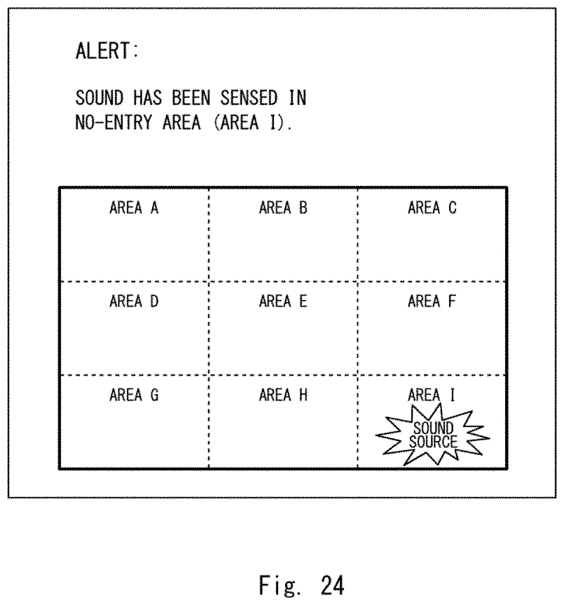

The report unit 40 may perform reporting when the generation position or generation area of the monitoring target sound, which is identified by the identification unit 30 is a predetermined area such as a no-entry area or a dangerous area. FIG. 24 illustrates an example in which this reporting is performed on a GUI screen. FIG. 24 illustrates an exemplary GUI screen when the predetermined area is an area I that is a no-entry area.

The report unit 40 may perform reporting when the generation position or generation area of the monitoring target sound, which is identified by the identification unit 30 is an adjacent area that is adjacent to a predetermined area such as a no-entry area or a dangerous area. FIG. 25 illustrates an example in which this reporting is performed on a GUI screen. FIG. 25 illustrates an exemplary GUI screen when the predetermined area is an area I that is a no-entry area.

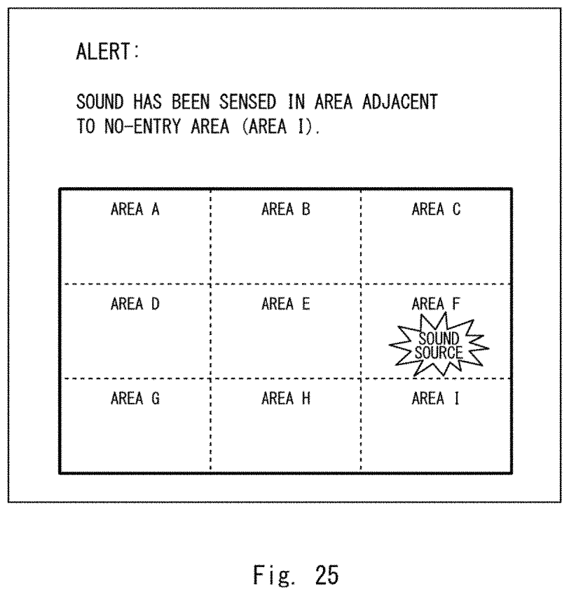

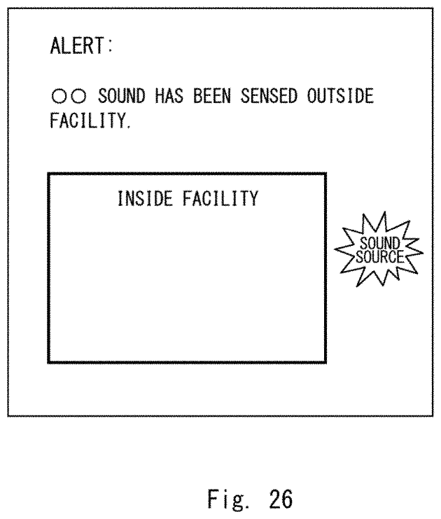

The report unit 40 may perform reporting when the generation position or generation area of the monitoring target sound, which is identified by the identification unit 30 is outside the monitoring target area. FIG. 26 illustrates an example in which this reporting is performed on a GUI screen. FIG. 26 illustrates an exemplary GUI screen when the monitoring target area is inside a facility.

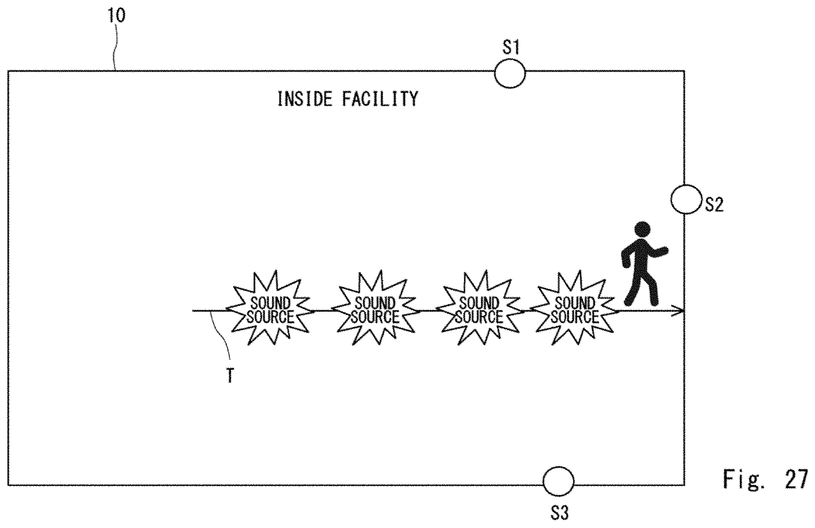

In an example illustrated in FIG. 27, the movement locus T of the monitoring target is identified by a method same as that in the above-described example of FIG. 18. The movement locus T of the monitoring target indicates that the monitoring target is moving toward the outside of a facility that is the monitoring target area, and the monitoring target potentially moves to the outside of the facility. In the above-described example illustrated in FIG. 20, as well, the movement locus T of the monitoring target indicates that the monitoring target has moved from the area B to the area C and is moving toward the outside of the monitoring target area, and thus the monitoring target potentially moves to the outside of the monitoring target area.

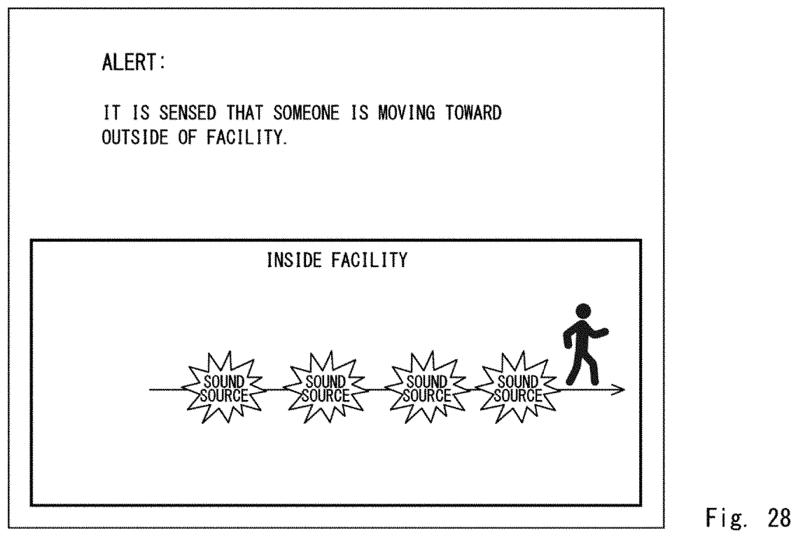

Thus, the report unit 40 may perform reporting when the movement locus T of the monitoring target extends toward the outside of the monitoring target area as in the examples illustrated in FIGS. 20 and 27. FIG. 28 illustrates an example in which this reporting is performed on a GUI screen. FIG. 28 illustrates an exemplary GUI screen when the monitoring target area is inside a facility.

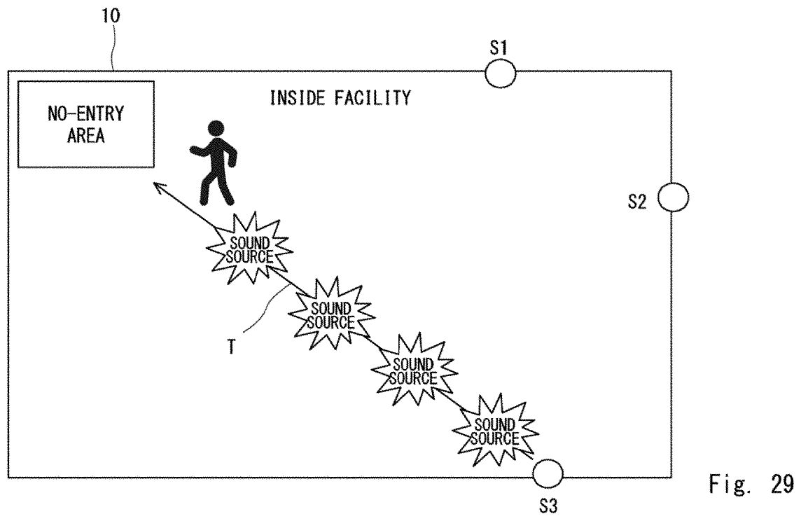

In an example illustrated in FIG. 29, the movement locus T of the monitoring target is identified by a method same as that in the above-described example of FIG. 18. The movement locus T of the monitoring target indicates that the monitoring target is approaching a no-entry area, and the monitoring target potentially enters the no-entry area. In the above-described example illustrated in FIG. 21, as well, the movement locus T of the monitoring target indicates that the monitoring target has moved from the area B to the area F through the area C and is approaching the area I that is a no-entry area, and the monitoring target potentially enters the area I.

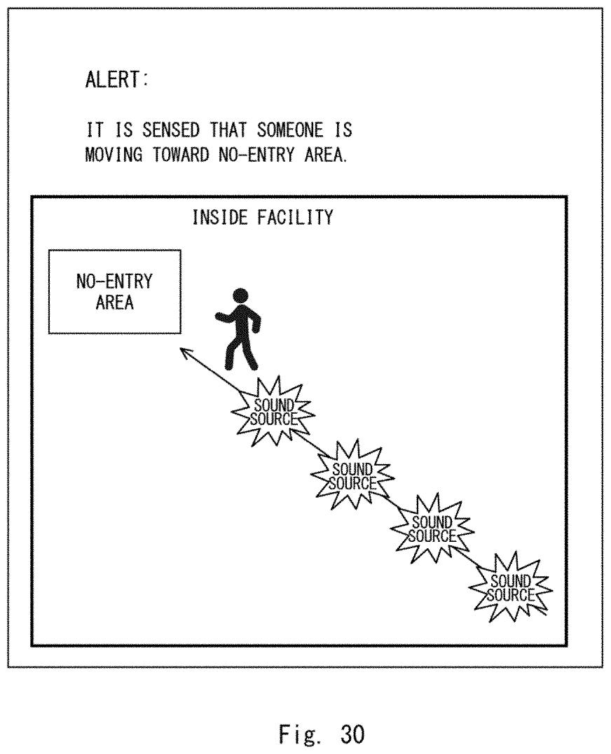

Thus, the report unit 40 may perform reporting when the movement locus T of the monitoring target is approaching a predetermined area such as a no-entry area or a dangerous area as in the examples illustrated in FIGS. 21 and 29. FIG. 30 illustrates an example in which this reporting is performed on a GUI screen. FIG. 30 illustrates an exemplary GUI screen when the predetermined area is a no-entry area inside a facility.

Examples of the predetermined event upon which the report unit 40 performs reporting as described above include:
the monitoring target sound is sensed
the generation position or generation area of the monitoring target sound is a predetermined area
the generation position or generation area of the monitoring target sound is an adjacent area that is adjacent to a predetermined area
the generation position or generation area of the monitoring target sound is outside the monitoring target area
the movement locus of the monitoring target extends toward the outside of the monitoring target area
the movement locus of the monitoring target is approaching a predetermined area

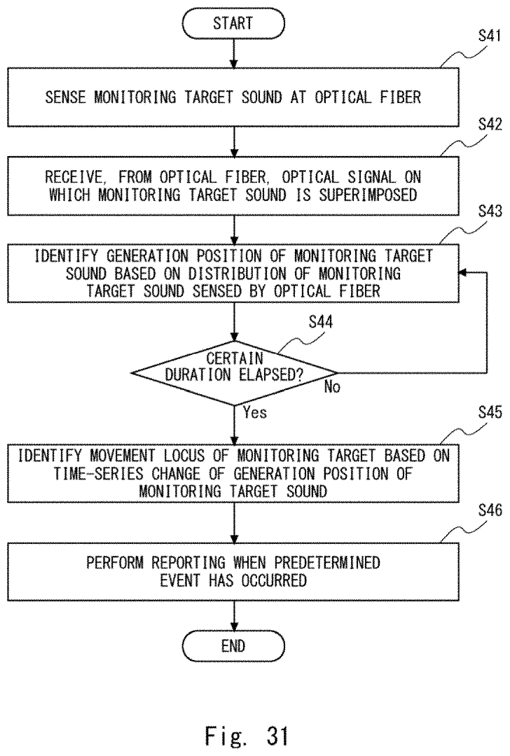

Subsequently, exemplary operation of the optical fiber sensing system according to the present fourth example embodiment will be described below with reference to FIG. 31. In the following description, it is assumed that the identification unit 30 repeats identification of the generation position of the monitoring target sound until a certain duration elapses.

As illustrated in FIG. 31, first, steps S41 to S45, which are same as steps S31 to S35 illustrated in FIG. 19, are performed.

Thereafter, the report unit 40 determines whether a predetermined event has occurred based on the generation position of the monitoring target sound and the movement locus of the monitoring target, which are identified by the identification unit 30, and performs reporting when the predetermined event has occurred (step S46). In this case, the report unit 40 may perform reporting by using, for example, the above-described GUI screens in FIGS. 23 to 26, 28, and 30.

Note that, in FIG. 31, the identification unit 30 identifies the movement locus of the monitoring target after a certain duration has elapsed, but may identify the movement locus of the monitoring target before the certain duration elapses.

FIG. 31 may additionally include a step in which the identification unit 30 identifies the generation area of the monitoring target sound. In this case, the report unit 40 may determine whether a predetermined event has occurred based on the generation area of the monitoring target sound, which is identified by the identification unit 30.

According to the present fourth example embodiment as described above, the report unit 40 performs reporting when having determined a predetermined event has occurred based on the generation position or generation area of the monitoring target sound and the movement locus of the monitoring target, which are identified by the identification unit 30. The predetermined event is, for example, sensing of danger indicating sound as the monitoring target sound as described above. Accordingly, when the predetermined event such as sensing of danger indicating sound has occurred, the occurrence can be reported.

### Exemplary Applications of Example Embodiments

Exemplary specific applications of the optical fiber sensing systems according to the above-described example embodiments will be described below.

For example, each optical fiber sensing system according to an above-described example embodiment may be applied to sense danger indicating sound such as gunshot sound or scream sound in a shopping mall or a theme park. In this exemplary application, when danger indicating sound is sensed, the generation position and generation area of the sound may be reported.

In addition, each optical fiber sensing system according to an above-described example embodiment may be applied to sense escape of a kid from a nursery school and sense entry of a suspicious person to the nursery school. In this exemplary application, when escape of a kid or entry of a suspicious person is sensed, the sensing may be reported.

In addition, each optical fiber sensing system according to an above-described example embodiment may be applied to sense escape of an animal from an animal rearing facility and sense entry of an animal into a predetermined area such as a no-entry area in the animal rearing facility. In this exemplary application, when escape of an animal or entry of an animal into the predetermined area is sensed, the sensing may be reported.

In addition, each optical fiber sensing system according to an above-described example embodiment may be applied to sense entry of a person into a predetermined area such as a no-entry area in a theme park and sense illegal entry through a place other than a legitimate park entrance. In this exemplary application, when entry to the predetermined area or illegal entry is sensed, the sensing may be reported.

In addition, each optical fiber sensing system according to an above-described example embodiment may be applied to sense escape of a prisoner from a prison and sense suspicious behavior of a prisoner in the prison. In this exemplary application, when escape or suspicious behavior of a prisoner is sensed, the sensing may be reported.

In addition, each optical fiber sensing system according to an above-described example embodiment may be applied to sense a suspicious behavior at an airport. In this exemplary application, when a suspicious behavior is sensed, the sensing may be reported.

<Hardware Configuration of Optical Fiber Sensing Instrument>

The reception unit 20, the identification unit 30, and the report unit 40 described above may be mounted on an optical fiber sensing instrument. The optical fiber sensing instrument on which the reception unit 20, the identification unit 30, and the report unit 40 are mounted may be achieved as a computer.

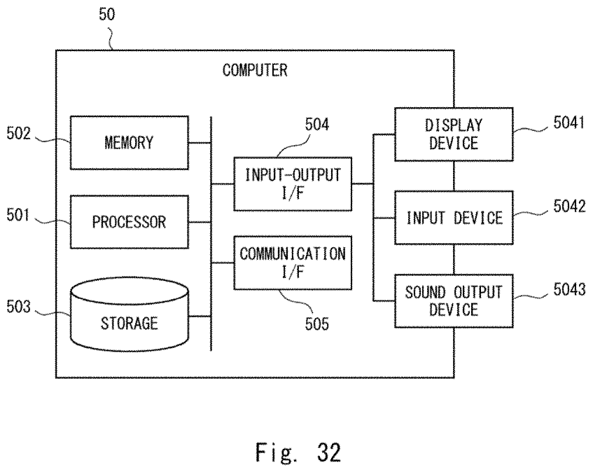

A hardware configuration of a computer 50 that achieves the optical fiber sensing instrument described above will be described below with reference to FIG. 32.

As illustrated in FIG. 32, the computer 50 includes a processor 501, a memory 502, a storage 503, an input-output interface (input-output I/F) 504, and a communication interface (communication I/F) 505. The processor 501, the memory 502, the storage 503, the input-output interface 504, and the communication interface 505 are connected to each other through a data transmission path for mutually transmitting and receiving data.

The processor 501 is an arithmetic processing device such as a central processing unit (CPU) or a graphics processing unit (GPU). The memory 502 is a memory such as a random access memory (RAM) or a read only memory (ROM). The storage 503 is a storage device such as a hard disk drive (HDD), a solid state drive (SSD), or a memory card. Alternatively, the storage 503 may be a memory such as a RAM or a ROM.

The storage 503 stores computer programs configured to achieve functions of components (the reception unit 20, the identification unit 30, and the report unit 40) included in the optical fiber sensing instrument. The processor 501 executes the computer programs to achieve the respective functions of the components included in the optical fiber sensing instrument. When executing the computer programs, the processor 501 may perform the execution after reading the computer programs onto the memory 502 or may perform the execution without reading the computer programs onto the memory 502. The memory 502 and the storage 503 also function to store information and data held by the components included in the optical fiber sensing instrument.

The above-described computer programs may be stored in non-transitory computer-readable media of various types and supplied to a computer (including the computer 50). The non-transitory computer-readable media include tangible storage media of various types. Examples of the non-transitory computer-readable media include magnetic storage media (such as a flexible disk, a magnetic tape, and a hard disk drive), a magneto-optical storage medium (such as a magneto optical disc), a Compact Disc-ROM (CD-ROM), a CD-Recordable (CD-R), a CD-Rewritable (CD-R/W), and semiconductor memories (such as a mask ROM, a programmable ROM (PROM), an erasable PROM (EPROM), a flash ROM, and a RAM). The computer programs may be supplied to the computer through transitory computer-readable media of various types. Examples of the transitory computer-readable media include an electric signal, an optical signal, and an electromagnetic wave. The transitory computer-readable media may supply the computer programs to the computer through a wired communication path such as an electrical line or an optical fiber or through a wireless communication path.

The input-output interface 504 is connected to a display device 5041, an input device 5042, a sound output device 5043, and the like. The display device 5041 is, for example, a liquid crystal display (LCD), a cathode ray tube (CRT) display, or a monitor, and is configured to display a screen corresponding to drawing data processed by the processor 501. The input device 5042 is a device configured to receive an operation input by an operator, and is, for example, a keyboard, a mouse, or a touch sensor. The display device 5041 and the input device 5042 may be integrated and achieved as a touch panel. The sound output device 5043 is a device configured to acoustically output sound corresponding to acoustic data processed by the processor 501 and is, for example, a speaker.

The communication interface 505 transmits and receives data to and from an external device. For example, the communication interface 505 communicates with the external device through a wired communication path or a wireless communication path.

The present disclosure is described above with reference to the example embodiments but not limited to the above-described example embodiments. The configurations and details of the present disclosure may be provided with various modifications that could be understood by the skilled person in the art within the scope of the present disclosure.

Some or all of the above-described example embodiments can be expressed as in the following supplementary notes but are not limited thereto.

(Supplementary note 1)

1. An optical fiber sensing system comprising:

an optical fiber disposed to lie in a plurality of directions and configured to sense sound generated in a monitored area;

a reception unit configured to receive, from the optical fiber, an optical signal on which the sound is superimposed; and

an identification unit configured to analyze distribution of the sound sensed by the optical fiber based on the optical signal and identify a generation position of the sound based on the analyzed distribution of the sound.

(Supplementary Note 2)

The optical fiber sensing system according to Supplementary Note 1, wherein the identification unit identifies a generation position of sound corresponding to a monitoring target registered in advance.

(Supplementary Note 3)

The optical fiber sensing system according to Supplementary Note 2, wherein the identification unit repeats identification of the generation position of the sound corresponding to the monitoring target and identifies a movement locus of the monitoring target based on time-series change of the generation position.

(Supplementary Note 4)

The optical fiber sensing system according to Supplementary Note 2 or 3, wherein the identification unit identifies a generation area of the sound corresponding to the monitoring target based on the analyzed distribution of the sound.

(Supplementary Note 5)

The optical fiber sensing system according to Supplementary Note 2 or 3, wherein the identification unit identifies a generation area of the sound corresponding to the monitoring target based on the generation position.

(Supplementary Note 6)

The optical fiber sensing system according to Supplementary Note 4 or 5, wherein the identification unit repeats identification of the generation area of the sound corresponding to the monitoring target and identifies a movement locus of the monitoring target based on time-series change of the generation area.

(Supplementary Note 7)

The optical fiber sensing system according to Supplementary Note 2 or 3, further comprising a report unit configured to perform reporting when the generation position is in a predetermined area.

(Supplementary Note 8)

The optical fiber sensing system according to Supplementary Note 2 or 3, further comprising a report unit configured to perform reporting when the generation position is outside the monitored area.

(Supplementary Note 9)

The optical fiber sensing system according to any one of Supplementary Notes 4 to 6, further comprising a report unit configured to perform reporting when the generation area is in a predetermined area.

(Supplementary Note 10)

The optical fiber sensing system according to any one of Supplementary Notes 4 to 6, further comprising a report unit configured to perform reporting when the generation area is outside the monitored area.

(Supplementary Note 11)

The optical fiber sensing system according to Supplementary Note 3 or 6, further comprising a report unit configured to perform reporting when the movement locus extends toward a predetermined area.

(Supplementary Note 12)

The optical fiber sensing system according to any one of Supplementary Notes 1 to 11, wherein the optical fiber is disposed around the monitored area.

(Supplementary Note 13)

The optical fiber sensing system according to any one of Supplementary Notes 1 to 11, wherein the optical fiber is disposed in the monitored area.

(Supplementary Note 14)

A sound source position identification method comprising:

a step of sensing, by an optical fiber disposed to lie in a plurality of directions, sound generated in a monitored area;

a step of receiving, from the optical fiber, an optical signal on which the sound is superimposed; and

an identification step of analyzing distribution of the sound sensed by the optical fiber based on the optical signal and identifying a generation position of the sound based on the analyzed distribution of the sound.

(Supplementary Note 15)

The sound source position identification method according to Supplementary Note 14, wherein the identification step identifies a generation position of sound corresponding to a monitoring target registered in advance.

(Supplementary Note 16)

The sound source position identification method according to Supplementary Note 15, wherein the identification step repeats identification of the generation position of the sound corresponding to the monitoring target and identifies a movement locus of the monitoring target based on time-series change of the generation position.

(Supplementary Note 17)

The sound source position identification method according to Supplementary Note 15 or 16, wherein the identification step identifies a generation area of the sound corresponding to the monitoring target based on the analyzed distribution of the sound.

(Supplementary Note 18)

The sound source position identification method according to Supplementary Note 15 or 16, in which the identification step identifies a generation area of the sound corresponding to the monitoring target based on the generation position.

(Supplementary Note 19)

The sound source position identification method according to Supplementary Note 17 or 18, in which the identification step the repeats identification of the generation area of the sound corresponding to the monitoring target and identifies a movement locus of the monitoring target based on time-series change of the generation area.

(Supplementary Note 20)

The sound source position identification method according to Supplementary Note 15 or 16, further including a report step of performing reporting when the generation position is in a predetermined area.

(Supplementary Note 21)

The sound source position identification method according to Supplementary Note 15 or 16, further including a report step of performing reporting when the generation position is outside the monitored area.

(Supplementary Note 22)

The sound source position identification method according to any one of Supplementary Notes 17 to 19, further including a report step of performing reporting when the generation area is in a predetermined area.

(Supplementary Note 23)

The sound source position identification method according to any one of Supplementary Notes 17 to 19, further including a report step of performing reporting when the generation area is outside the monitored area.

(Supplementary Note 24)

The sound source position identification method according to Supplementary Note 16 or 19, further including a report step of performing reporting when the movement locus extends toward a predetermined area.

(Supplementary Note 25)

The sound source position identification method according to any one of Supplementary Notes 14 to 24, in which the optical fiber is disposed around the monitored area.

(Supplementary Note 26)

The sound source position identification method according to any one of Supplementary Notes 14 to 24, in which the optical fiber is disposed in the monitored area.

### REFERENCE SIGNS LIST

10 OPTICAL FIBER
20 RECEPTION UNIT
30 IDENTIFICATION UNIT
31 EXTRACTION UNIT
32 MATCHING UNIT
33 SOUND GENERATION POSITION IDENTIFICATION UNIT
34 SOUND GENERATION AREA IDENTIFICATION UNIT
35 TRACE UNIT
40 REPORT UNIT
50 COMPUTER
501 PROCESSOR
502 MEMORY
503 STORAGE
504 INPUT-OUTPUT INTERFACE
5041 DISPLAY DEVICE
5042 INPUT DEVICE
5043 SOUND OUTPUT DEVICE
505 COMMUNICATION INTERFACE

What is claimed is:

1. An optical fiber sensing system comprising:
an optical fiber disposed to lie in a plurality of directions and configured to sense sound generated in a monitored area;
a reception unit configured to receive, from the optical fiber, an optical signal on which the sound is superimposed; and
an identification unit configured to analyze distribution of the sound sensed by the optical fiber based on the optical signal and identify a generation position of the sound based on the analyzed distribution of the sound.

2. The optical fiber sensing system according to claim 1, wherein the identification unit identifies a generation position of sound corresponding to a monitoring target registered in advance.

3. The optical fiber sensing system according to claim 2, wherein the identification unit repeats identification of the generation position of the sound corresponding to the monitoring target and identifies a movement locus of the monitoring target based on time-series change of the generation position.

4. The optical fiber sensing system according to claim 2, wherein the identification unit identifies a generation area of the sound corresponding to the monitoring target based on the analyzed distribution of the sound.

5. The optical fiber sensing system according to claim 2, wherein the identification unit identifies a generation area of the sound corresponding to the monitoring target based on the generation position.

6. The optical fiber sensing system according to claim 4, wherein the identification unit repeats identification of the generation area of the sound corresponding to the monitoring target and identifies a movement locus of the monitoring target based on time-series change of the generation area.

7. The optical fiber sensing system according to claim 2, further comprising a report unit configured to perform reporting when the generation position is in a predetermined area.

8. The optical fiber sensing system according to claim 2, further comprising a report unit configured to perform reporting when the generation position is outside the monitored area.

9. The optical fiber sensing system according to claim 4, further comprising a report unit configured to perform reporting when the generation area is in a predetermined area.

10. The optical fiber sensing system according to claim 4, further comprising a report unit configured to perform reporting when the generation area is outside the monitored area.

11. The optical fiber sensing system according to claim 3, further comprising a report unit configured to perform reporting when the movement locus extends toward a predetermined area.

12. The optical fiber sensing system according to claim 1, wherein the optical fiber is disposed around the monitored area.

13. The optical fiber sensing system according to claim 1, wherein the optical fiber is disposed in the monitored area.

14. A sound source position identification method comprising:
a step of sensing, by an optical fiber disposed to lie in a plurality of directions, sound generated in a monitored area;
a step of receiving, from the optical fiber, an optical signal on which the sound is superimposed; and
an identification step of analyzing distribution of the sound sensed by the optical fiber based on the optical signal and identifying a generation position of the sound based on the analyzed distribution of the sound.

15. The sound source position identification method according to claim 14, wherein the identification step identifies a generation position of sound corresponding to a monitoring target registered in advance.

16. The sound source position identification method according to claim 15, wherein the identification step repeats identification of the generation position of the sound corresponding to the monitoring target and identifies a movement locus of the monitoring target based on time-series change of the generation position.

17. The sound source position identification method according to claim 15, wherein the identification step identifies a generation area of the sound corresponding to the monitoring target based on the analyzed distribution of the sound.
